(19) United States
(12) Patent Application Publication
(10) Pub. No.: US 2018/0011538 A1
(43) Pub. Date: Jan. 11, 2018

(54) MULTIMODAL HAPTIC EFFECTS

(71) Applicant: IMMERSION CORPORATION, San Jose, CA (US)

(72) Inventors: WILLIAM S. RIHN, SAN JOSE, CA (US); SANYA ATTARI, FREMONT, CA (US); LIWEN WU, MONTREAL (CA); MIN LEE, SANTA CLARA, CA (US); DAVID BIRNBAUM, OAKLAND, CA (US)

(21) Appl. No.: 15/643,802

(22) Filed: Jul. 7, 2017

Related U.S. Application Data
(60) Provisional application No. 62/360,036, filed on Jul. 8, 2016.

(51) Int. Cl. G06F 3/01; G06F 3/0488; G06F 3/0484

(52) U.S. Cl. CPC G06F 3/016; G06F 3/04847; G06F 3/04883

(57) ABSTRACT

Embodiments generate haptic effects in response to a user input (e.g., pressure based or other gesture). Embodiments receive a first input range corresponding to user input and receive a haptic profile corresponding to the first input range. During a first dynamic portion of the haptic profile, embodiments generate a dynamic haptic effect that varies based on values of the first input range during the first dynamic portion. Further, at a first trigger position of the haptic profile, embodiments generate a triggered haptic effect.

### CROSS REFERENCE TO RELATED APPLICATIONS

This application claims priority of U.S. Provisional Patent Application Ser. No. 62/360,036, filed on Jul. 8, 2016, the disclosure of which is hereby incorporated by reference.

### FIELD

One embodiment is directed generally to haptic effects, and in particular to the generation of multimodal haptic effects.

### BACKGROUND INFORMATION

Portable/mobile electronic devices, such as mobile phones, smartphones, camera phones, cameras, personal digital assistants (“PDA”s), etc., typically include output mechanisms to alert the user of certain events that occur with respect to the devices. For example, a cell phone normally includes a speaker for audibly notifying the user of an incoming telephone call event. The audible signal may include specific ringtones, musical tunes, sound effects, etc. In addition, cell phones and smartphones may include display screens that can be used to visually notify the users of incoming phone calls.

In some mobile devices, kinesthetic feedback (such as active and resistive force feedback) and/or tactile feedback (such as vibration, texture, and heat) is also provided to the user, more generally known collectively as “haptic feedback” or “haptic effects”. Haptic feedback can provide cues that enhance and simplify the user interface. Specifically, vibration effects, or vibrotactile haptic effects, may be useful in providing cues to users of electronic devices to alert the user to specific events, or provide realistic feedback to create greater sensory immersion within a simulated or virtual environment.

### SUMMARY

Embodiments generate haptic effects in response to a user input (e.g., pressure based or other gesture). Embodiments receive a first input range corresponding to user input and receive a haptic profile corresponding to the first input range. During a first dynamic portion of the haptic profile, embodiments generate a dynamic haptic effect that varies based on values of the first input range during the first dynamic portion. Further, at a first trigger position of the haptic profile, embodiments generate a triggered haptic effect.

### BRIEF DESCRIPTION OF THE DRAWINGS

FIG. 1 is a block diagram of a haptically-enabled multimodal mobile device/system that can implement an embodiment of the present invention.

FIG. 2 illustrates a graphical representation of an embodiment for providing haptic effects in response to a pressure-based input.

FIG. 3 illustrates a graphical representation of an embodiment for providing haptic effects in response to a pressure-based input.

FIG. 4 illustrates an example of simulating button presses with multimodal haptic effects in accordance with one embodiment.

FIG. 5 illustrates an example of simulating different materials with multimodal haptic effects in accordance with one embodiment.

FIG. 6 illustrates an example of simulating the texture of the materials of FIG. 5 as user slides a finger across the materials in an x-y axis plane of the touchscreen.

FIG. 7 illustrates a granular synthesis tool in accordance to embodiments of the invention.

FIG. 8 is a flow diagram of the functionality of the system of FIG. 1 when generating a multimodal haptic effect in accordance with an embodiment.

FIG. 9 is a flow diagram of the functionality of the system of FIG. 1 when generating a multimodal haptic effect in accordance with an embodiment.

FIG. 10 illustrates force profiles of four different mechanical switches and corresponding haptic profiles in accordance with embodiments of the invention.

### DETAILED DESCRIPTION

Embodiments of the invention generate multimodal haptic effects that combine dynamically generated haptic effects based on a range of user input combined with pre-designed static haptic effects that can be triggered at certain thresholds during the range of user input. The multimodal haptic effects can be generated in response to both pressure based input and x-y axis positional inputs. The multimodal haptic effects can be used to mimic real world physical properties of elements, such as the properties of materials or physical buttons, as a user applies pressure on simulations of these real world elements or traverses the surface of these elements.

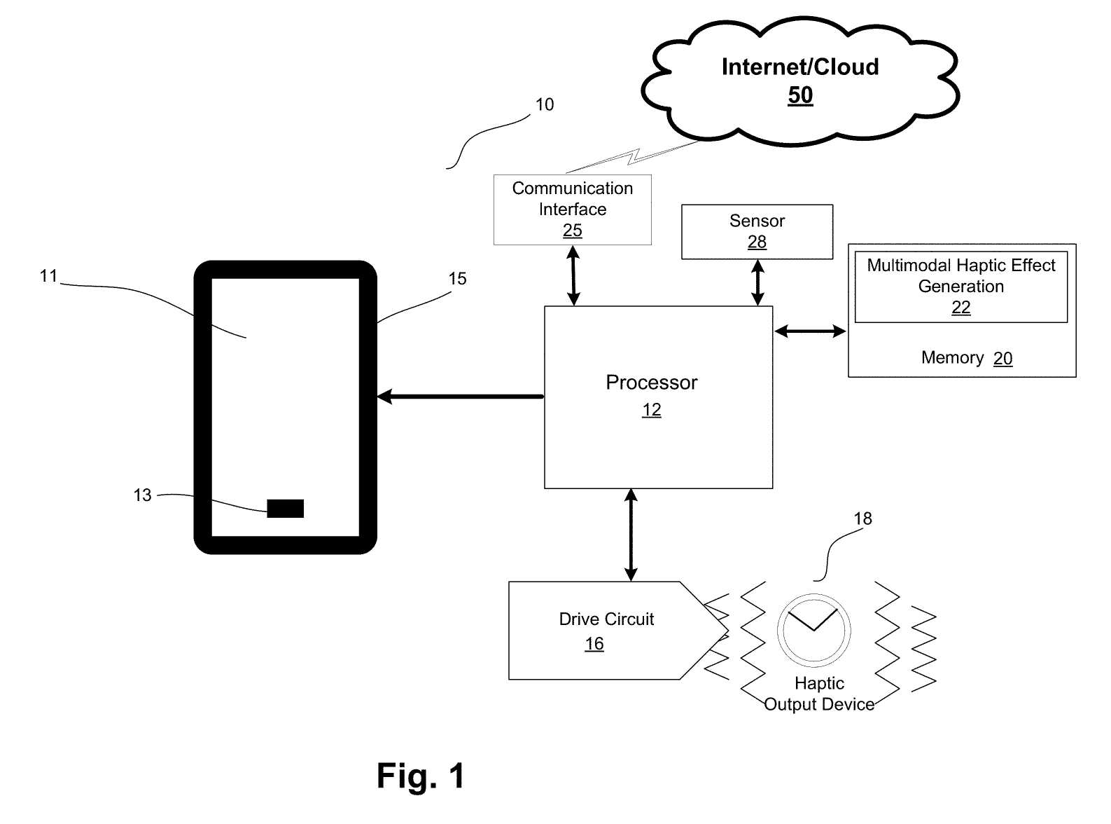

FIG. 1 is a block diagram of a haptically-enabled mobile device/system 10 that can implement an embodiment of the present invention. System 10 includes a touch sensitive surface or touchscreen 11 or other type of touch sensitive user interface mounted within a housing 15, and may include mechanical keys/buttons 13. System 10 can be any type device that includes a touch sensitive user interface/touchscreen 11, including a smartphone, a tablet, a desktop or laptop computer system with touchscreen, a game controller, any type of wearable device, etc.

Internal to system 10 is a haptic feedback system that generates haptic effects on system 10. The haptic feedback system includes a processor or controller 12. Coupled to processor 12 is a memory 20 and a drive circuit 16, which is coupled to a haptic output device 18. Processor 12 may be any type of general purpose processor, or could be a processor specifically designed to provide haptic effects, such as an application-specific integrated circuit (“ASIC”). Processor 12 may be the same processor that operates the entire system 10, or may be a separate processor. Processor 12 can decide what haptic effects are to be played and the order in which the effects are played based on high level parameters. In general, the high level parameters that define a particular haptic effect include magnitude, frequency and duration. Low level parameters such as streaming motor commands could also be used to determine a particular haptic effect. A haptic effect may be considered “dynamic” if it includes some variation of these parameters when the haptic effect is generated or a variation of these parameters based on a user's interaction.

Processor 12 outputs the control signals to drive circuit 16, which includes electronic components and circuitry used to supply haptic output device 18 with the required electrical current and voltage (i.e., “motor signals”) to cause the desired haptic effects to be generated. System 10 may include more than one haptic output device 18, and each haptic output device may include a separate drive circuit 16, all coupled to a common processor 12. Memory device 20 can be any type of storage device or computer-readable medium, such as random access memory (“RAM”) or read-only memory (“ROM”). Memory 20 stores instructions executed by processor 12, such as operating system instructions. Among the instructions, memory 20 includes a multimodal haptic effect generation module 22 which is instructions that, when executed by processor 12, generate multimodal haptic effects disclosed in more detail below. Memory 20 may also be located internal to processor 12, or any combination of internal and external memory.

Touch surface or touchscreen 11 recognizes touches, and may also recognize the position and magnitude of touches on the surface. The data corresponding to the touches is sent to processor 12, or another processor within system 10, and processor 12 interprets the touches and in response generates haptic effect signals. Touch surface 11 may sense touches using any sensing technology, including capacitive sensing, resistive sensing, surface acoustic wave sensing, pressure sensing, optical sensing, etc. Touch surface 11 may sense multi-touch contacts and may be capable of distinguishing multiple touches that occur at the same time. Touch surface 11 may be a touchscreen that generates and displays images for the user to interact with, such as keys, buttons, dials, etc., or may be a touchpad with minimal or no images.

Haptic output device 18 may be any type of device that generates haptic effects, and can be physically located in any area of system 10 to be able to create the desired haptic effect to the desired area of a user's body.

In one embodiment, haptic output device 18 is an actuator that generates vibrotactile haptic effects. Actuators used for this purpose may include an electromagnetic actuator such as an Eccentric Rotating Mass (“ERM”) in which an eccentric mass is moved by a motor, a Linear Resonant Actuator (“LRA”) in which a mass attached to a spring is driven back and forth, or a “smart material” such as piezoelectric, electroactive polymers or shape memory alloys. Haptic output device 18 may also be a device such as an electrostatic friction (“ESF”) device or an ultrasonic surface friction (“USF”) device, or a device that induces acoustic radiation pressure with an ultrasonic haptic transducer. Other devices can use a haptic substrate and a flexible or deformable surface, and devices can provide projected haptic output such as a puff of air using an air jet, etc. Haptic output device 18 can further be a device that provides thermal haptic effects (e.g., heats up or cools off).

Although a single haptic output device 18 is shown in FIG. 1, some embodiments may use multiple haptic output devices of the same or different type to provide haptic feedback. Some haptic effects may utilize an actuator coupled to a housing of the device, and some haptic effects may use multiple actuators in sequence and/or in concert. For example, in some embodiments, multiple vibrating actuators and electrostatic actuators can be used alone or in concert to provide different haptic effects. In some embodiments, haptic output device 18 may include a solenoid or other force or displacement actuator, which may be coupled to touch sensitive surface 11. Further, haptic output device 18 may be either rigid or flexible.

System 10 further includes a sensor 28 coupled to processor 12. Sensor 28 can be used to detect any type of properties of the user of system 10 (e.g., a biomarker such as body temperature, heart rate, etc.), or of the context of the user or the current context (e.g., the location of the user, the temperature of the surroundings, etc.).

Sensor 28 can be configured to detect a form of energy, or other physical property, such as, but not limited to, sound, movement, acceleration, physiological signals, distance, flow, force/pressure/strain/bend, humidity, linear position, orientation/inclination, radio frequency, rotary position, rotary velocity, manipulation of a switch, temperature, vibration, or visible light intensity. Sensor 28 can further be configured to convert the detected energy, or other physical property, into an electrical signal, or any signal that represents virtual sensor information. Sensor 28 can be any device, such as, but not limited to, an accelerometer, an electrocardiogram, an electroencephalogram, an electromyograph, an electrooculogram, an electropalatograph, a galvanic skin response sensor, a capacitive sensor, a hall effect sensor, an infrared sensor, an ultrasonic sensor, a pressure sensor, a fiber optic sensor, a flexion sensor (or bend sensor), a force-sensitive resistor, a load cell, a LuSense CPS² 155, a miniature pressure transducer, a piezo sensor, a strain gage, a hygrometer, a linear position touch sensor, a linear potentiometer (or slider), a linear variable differential transformer, a compass, an inclinometer, a magnetic tag (or radio frequency identification tag), a rotary encoder, a rotary potentiometer, a gyroscope, an on-off switch, a temperature sensor (such as a thermometer, thermocouple, resistance temperature detector, thermistor, or temperature-transducing integrated circuit), a microphone, a photometer, an altimeter, a biological monitor, a camera, or a light-dependent resistor.

When used as a pressure sensor, sensor 28 (which may be integrated within touchscreen 11) is configured to detect an amount of pressure exerted by a user against touchscreen 11. Pressure sensor 28 is further configured to transmit sensor signals to processor 12. Pressure sensor 28 may include, for example, a capacitive sensor, a strain gauge, or a force sensitive resistor (“FSR”). In some embodiments, pressure sensor 28 may be configured to determine the surface area of a contact between a user and touchscreen 11.

System 10 further includes a communication interface 25 that allows system 10 to communicate over the Internet/cloud 50. Internet/cloud 50 can provide remote storage and processing for system 10 and allow system 10 to communicate with similar or different types of devices. Further, any of the processing functionality described herein can be performed by a processor/controller remote from system 10 and communicated via interface 25.

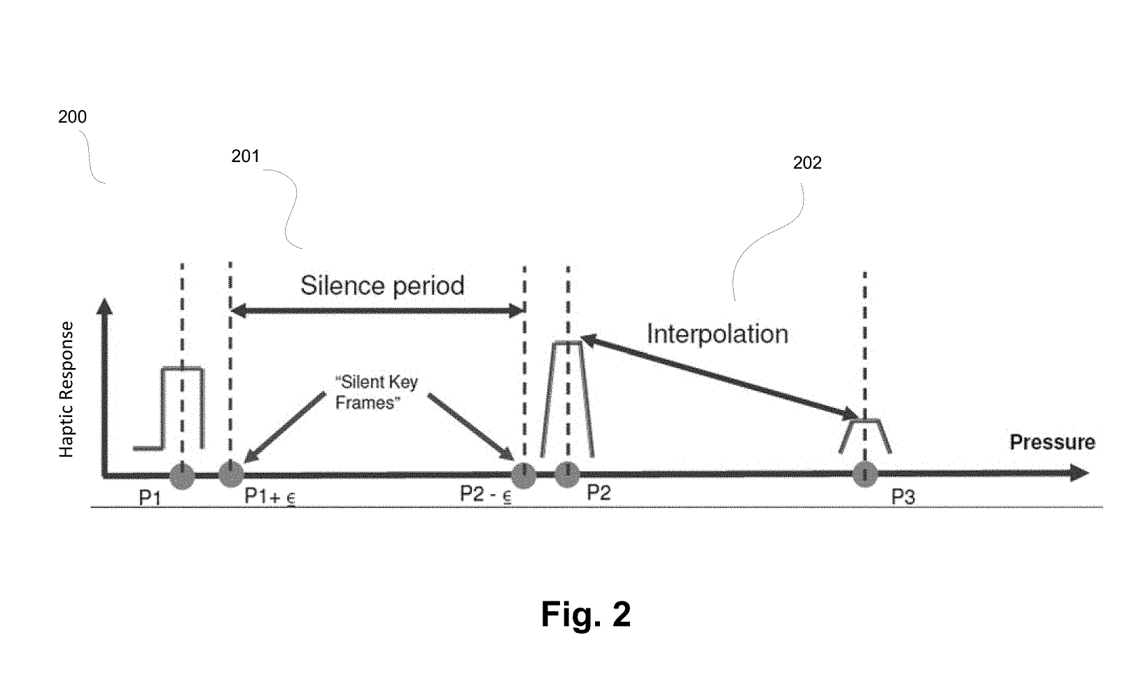

Embodiments provide haptic effects in response to at least two types of inputs to system 10. One type of input is a pressure-based input along approximately the Z-axis of touchscreen 11. The pressure-based input includes a range of pressure values as the amount of pressure increases or decreases. FIG. 2 illustrates a graphical representation of an embodiment for providing haptic effects in response to a pressure-based input. While active, system 10 monitors for a predefined pressure values or “key frames” P1, P2, P3, . . . PN. If pressure value P1 is detected by some pressure gesture applied to a surface, the system may or may not take some action, and continue monitoring for pressure values P2, P3, . . . PN. Silent key frames, called P1+ [symbol] and P2− [symbol] C in the figure, ensure that the haptic response stops when these pressure values are reached or crossed. When pressure values fall between P1 and P2, no haptic effect will be produced and no interpolation is required, because the values between two silent key frames constitute a silent period 201. Between key frames P2 and P3, the system provides interpolation 202 between the haptic output values associated with key frames P2 and P3, to provide transitional haptic effects between the haptic response accompanying P2 and the haptic response accompanying P3. Interpolation and interpolated effects are features employed to modulate or blend effects associated with multiple specified haptic feedback effects. In another embodiment, instead of interpolation, granular synthesis is used, as disclosed in detail below.

The functionality of FIG. 2 provides the ability to distinguish between haptic effects to be played when pressure is increasing and haptic effects to be played when pressure is decreasing. The functionality of FIG. 2 further prevents haptic effects from being skipped when pressure increases too fast. For example, when pressure goes from 0 to max, all effects associated with the interim pressure levels will be played. Further, a silence gap will be implemented between the effects in case they need to be played consecutively.

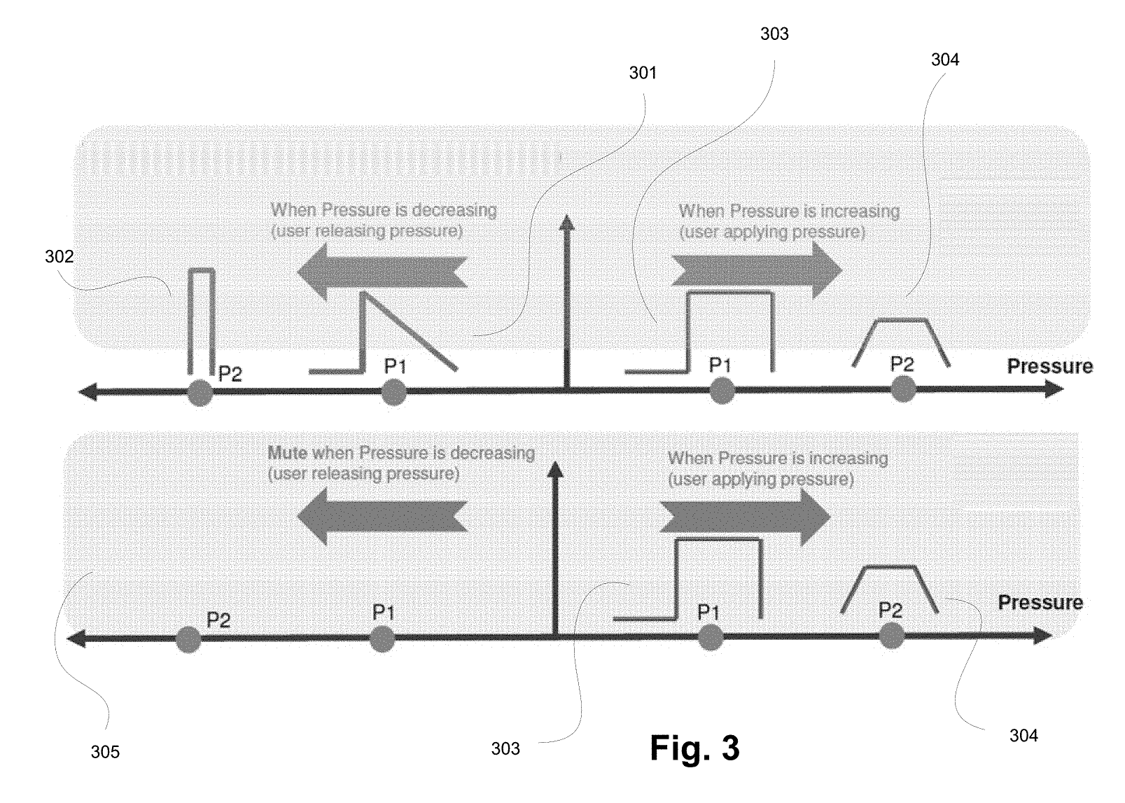

FIG. 3 illustrates a graphical representation of an embodiment for providing haptic effects in response to a pressure-based input. In one embodiment, the system identifies whether P2 is a larger or smaller magnitude than P1 and may provide different haptic responses based on whether the pressure applied is increasing or decreasing. In some embodiments, increasing and decreasing pressure situations result in two different sets of haptic responses, with haptic responses 301, 302 corresponding to decreasing pressure application and haptic responses 303, 304 corresponding to increasing pressure application. In some embodiments, increasing pressure situations will generate haptic responses, while decreasing pressure situations will result in no haptic effect 305. As in FIG. 2, different haptic effects 301-304 may be generated in response to multiple levels of pressure being applied. Silent key frames are utilized in embodiments where effect interpolation is not the intended outcome. As multiple pressure levels are applied, i.e., P1, P2, P3, . . . PN, an embodiment ensures that each effect associated with each pressure level is generated. In an embodiment, a silence gap may be generated between subsequent effects to ensure the user is able to distinguish and understand the haptic feedback.

In addition to pressure based, another type of input is a gesture type input along the x-y axis of touchscreen 11. A gesture is any movement of the object (e.g., a user's finger or stylus) that conveys meaning or user intent. It will be recognized that simple gestures may be combined to form more complex gestures. For example, bringing a finger into contact with a touch sensitive surface may be referred to as a “finger on” gesture, while removing a finger from a touch sensitive surface may be referred to as a separate “finger off” gesture. If the time between the “finger on” and “finger off” gestures is relatively short, the combined gesture may be referred to as “tapping”; if the time between the “finger on” and “finger off” gestures is relatively long, the combined gesture may be referred to as “long tapping”; if the distance between the two dimensional (x,y) positions of the “finger on” and “finger off” gestures is relatively large, the combined gesture may be referred to as “sliding”; if the distance between the two dimensional (x,y) positions of the “finger on” and “finger off” gestures is relatively small, the combined gesture may be referred to as “swiping”, “smudging” or “flicking”. Any number of two dimensional or three dimensional simple or complex gestures may be combined in any manner to form any number of other gestures, including, but not limited to, multiple finger contacts, palm or first contact, or proximity to the device. A gesture can also be any form of hand movement recognized by a device having an accelerometer, gyroscope, or other motion sensor, and converted to electronic signals. Such electronic signals can activate a dynamic effect, such as shaking virtual dice, where the sensor captures the user intent that generates a dynamic effect. As with pressure-based input, a gesture based input can be associated with a range of input, such as a slide gesture across touchscreen 11 from point A to point B.

As disclosed, haptic effects can be generated along a range of input. These haptic effects can be considered dynamic haptic effects, and can be generated using interpolation or granular synthesis. Using granular synthesis, the input can spawn or generate several short slices of signal or waveforms, and each waveform can be combined with an envelope to create a “grain.” Several grains can be generated, either concurrently, sequentially, or both, and the grains can be combined to form a “cloud.” The cloud can then be used to synthesize a haptic signal, and the haptic signal can subsequently be used to generate the haptic effect. The input can be optionally modified through either frequency-shifting, or a combination of frequency-shifting and filtering, before granular synthesis is applied to the input. In one embodiment, individual grains with different parameters per update are generated according to the input value (e.g., pressure, position, travel distance). Additional details of granular synthesis are disclosed, for example, in U.S. Pat. No. 9,257,022, the disclosure of which is hereby incorporated by reference.

If the user input is pressure based the dynamic haptic effect may be varied depending on whether the user input corresponds to increasing pressure or decreasing pressure. If the user input is a slide gesture, the dynamic haptic effect may be varied depending on the direction and velocity of the slide gesture. If the user input includes both pressure based input and a slide gesture, the dynamic haptic effect may be varied based on different combinations of velocity and direction.

In addition to generating a dynamic haptic effect in response to a range based input (e.g., a pressure based input or gesture based input), embodiments add additional pre-designed “static” haptic effects at certain predefined “trigger” points that fall along the range. The trigger points are defined at certain thresholds for pressure-based inputs, or at certain x-y axis coordinates for gesture based inputs, or a combination of the two. By combining both dynamic and static haptic effects along a range, the overall haptic effects are enhanced. For example, haptic effects that simulate materials, such as wood, or a mechanical button, generate haptic effects in response to pressure on the “wood” or the “button”. At certain points during the range, the compliance of the simulation changes, such when a fiber in the wood strains or breaks. The triggered static haptic effects assist in simulating the compliance.

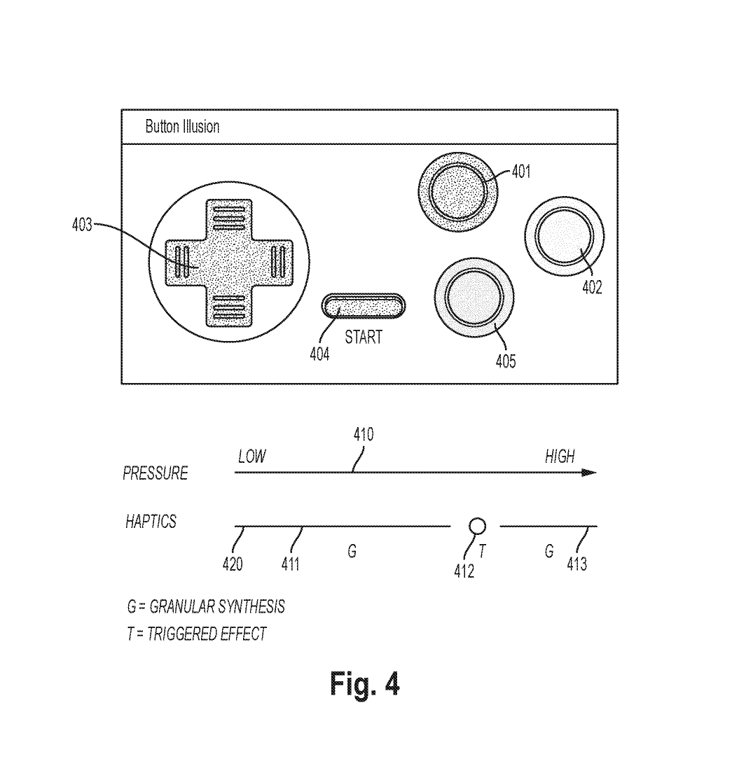

FIG. 4 illustrates an example of simulating button presses with multimodal haptic effects in accordance with one embodiment. Multiple “buttons” 401-405 are displayed on pressure sensitive touchscreen 11 of FIG. 1. Buttons 401-405 are displayed graphically to represent actual physical buttons. Each button can be “pushed” or “depressed” on touchscreen 11 by a user applying pressure along the z axis on the x-y axis coordinates that correspond to the placement of the button. Feedback about the state of the button and how far it is “pushed” can be provided by a combination of multimodal haptic feedback, audio feedback, and visual feedback, to create a multi-sensory illusion that the button is being pushed down.

Each button can have a corresponding input pressure range 410 of applied pressure values from low to high. The pressure values can be based on actual pressure, or some type of “pseudo-pressure” calculation, such as a measurement of an amount of contact with a user of the touchscreen (i.e., the more contact, the more pressure).

Corresponding to pressure range 410 is a haptic profile/range 420 that includes a first range 411 (or a “dynamic portion”) of dynamic haptic effects generated by granular synthesis, followed by a trigger point 412 (or a “trigger position”) that triggers a static predefined haptic effect, followed by a second range 413 of dynamic haptic effects generated by granular synthesis. Haptic range 420 functions as a haptic profile of an object (i.e., one or more of buttons 401-405). Based on the ranges, a user will feel haptic effects, hear audio effects, and see visual effects as the button is pushed along its travel range (411), will experience the triggered haptic effect and/or sound effect and/or visual effect as the bottom/end of the button travel range is met (412), and then additional dynamic and/or multi-sensory effects as a user further pushes on the button after the button is fully depressed (413). After a physical button is fully depressed, there may be some compliance of the material of which the button is made (for example, plastic), that results in further multi-sensory feedback (shown at 413) as pressure is increased even after the button's range of travel has been reached. As a result of the combination of dynamic haptic effects and a static haptic effect, the movement of the “buttons” mimic real buttons.

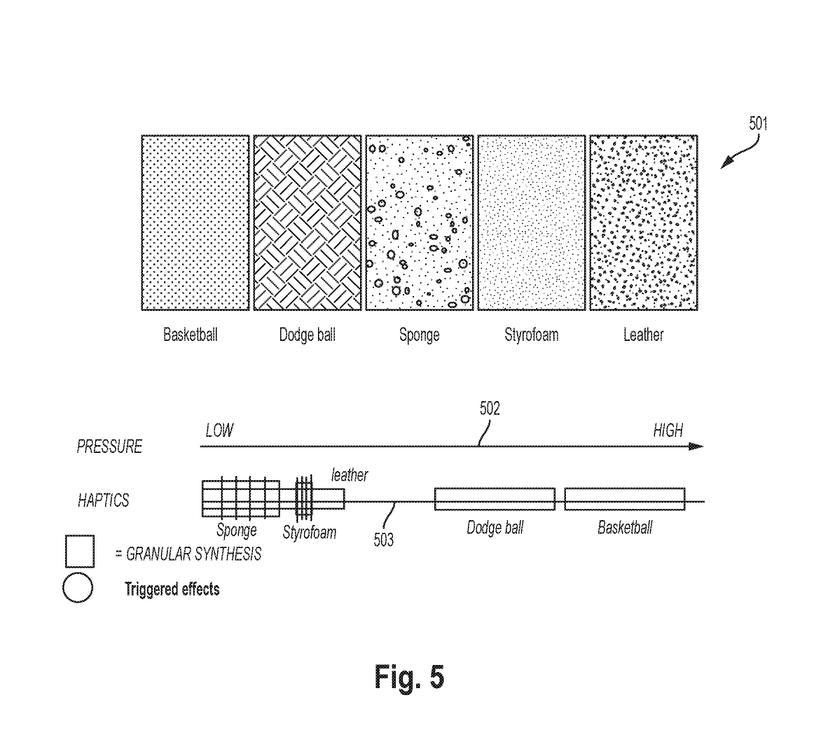

FIG. 5 illustrates an example of simulating different materials with multimodal haptic effects in accordance with one embodiment. Multiple “materials” 501 are displayed on pressure sensitive touchscreen 11, including a basketball, a dodge ball, a sponge, Styrofoam and leather. Materials 501 are displayed graphically to represent actual corresponding physical materials. A pressure range 502 and corresponding haptic profile/range 503 is also shown. Within haptic range 503, different haptic effects corresponding to different materials are shown. Each haptic effect includes a combination of dynamic haptic effects, implemented by granular synthesis, and one or more triggered haptic effects. As a result of the ranges in 503, the compliance of each of the materials can be simulated as increasing pressure is applied. For example, a sponge will be relatively easy to press on, and will provide a consistent give. In contrast, Styrofoam provides relative stiff resistance with any pressure, and with more pressure portions will start cracking/breaking, which will be simulated by the static triggered effects. The compliance effect may be more pronounced if one of the materials was wood, as disclosed below. When a triggered static haptic effect is used to simulate compliance, the triggered points will be shown within the range for the corresponding material on range 503, as shown for the sponge and the Styrofoam.

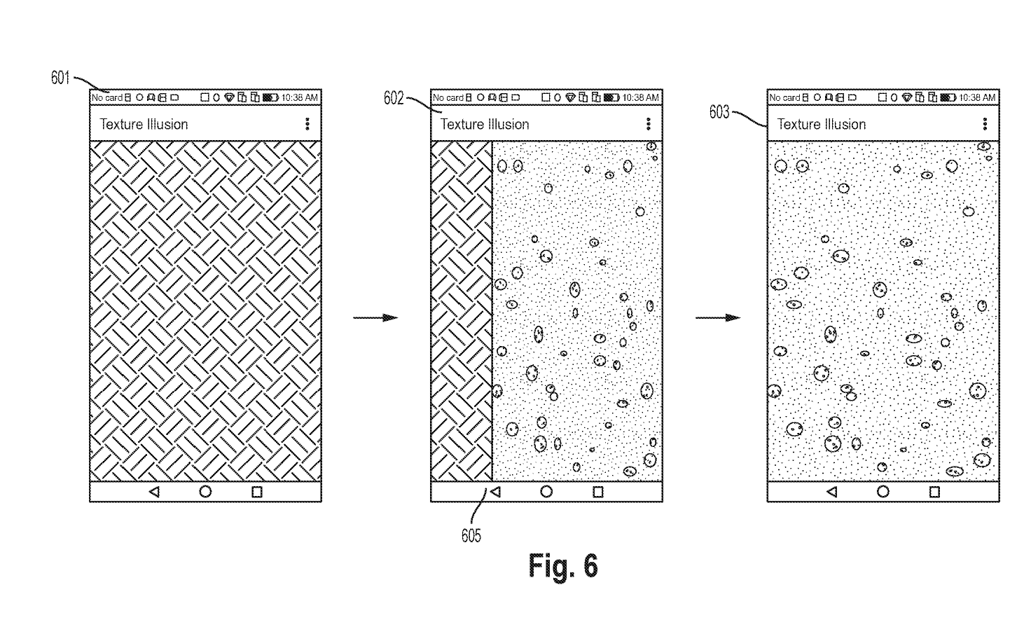

FIG. 6 illustrates an example of simulating the texture of the materials 501 of FIG. 5 as user slides a finger or other object across the materials in an x-y axis plane of touchscreen 11. In the example shown in FIG. 6, a user is traversing from the dodge ball in 601 to the sponge in 603, with the transition shown at 602 between the materials. While contacting a particular material, granular synthesis is used to simulate the texture of the material. A disclosure of simulating the texture of materials is disclosed in U.S. Pat. No. 9,330,544, the disclosure of which is hereby incorporated by reference. As a user approaches a transition where a gap between materials may exist, such as shown at 603, a trigger static haptic effect simulates the gap. Then, different granular synthesis is used to simulate the next material. In another embodiment, if the materials were wood planks in a floor, the gaps between each plank would be simulated using the static haptic effect between the dynamic haptic effects that simulate the texture of the wood planks.

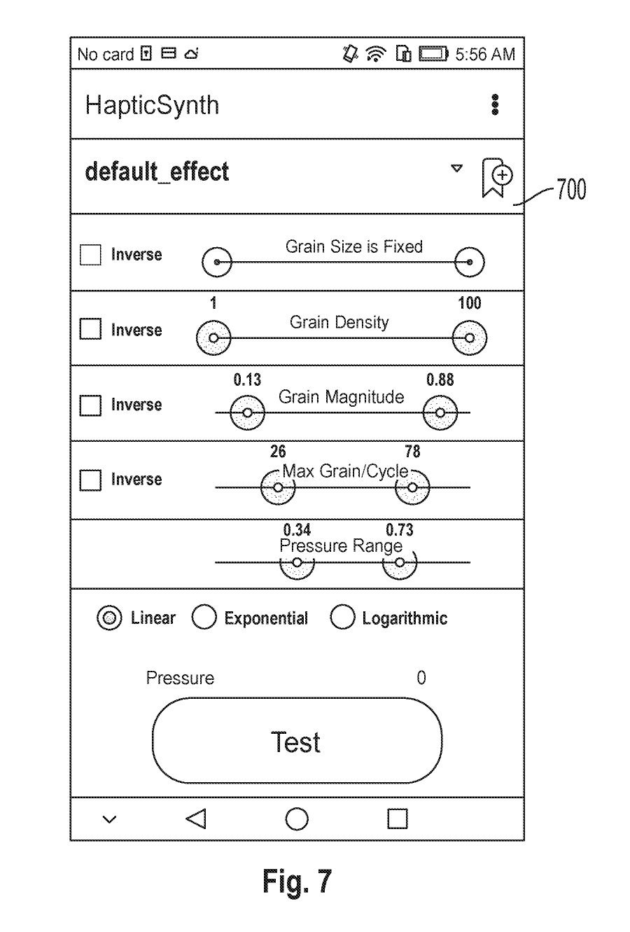

FIG. 7 illustrates a granular synthesis tool 700 in accordance to embodiments of the invention. In FIG. 7, the user interface of tool 700 is shown. Tool 700 allows a user to specify grain size, grain density, grain magnitude, maximum grains per cycle, and a pressure range. Tool 700 allows for parameter rendering with start key frame and end key frame, inverse rendering, load preset from .xml files, save a new haptic effect to an .xml file and effect design for different pressure levels. Tool 700 also allows for a live preview of the effect parameter settings, so that the effect designer can immediately feel the result of changing the position(s) of the controls. Additionally, tool 700 allows for synchronized audio feedback, whereby an audio signal is synthesized alongside the haptic signal and can be created to be well-matched to it. Further, tool 700 provides a visual overlay so that the haptic and audio effects can be experienced in the context of an image of the material being simulated.

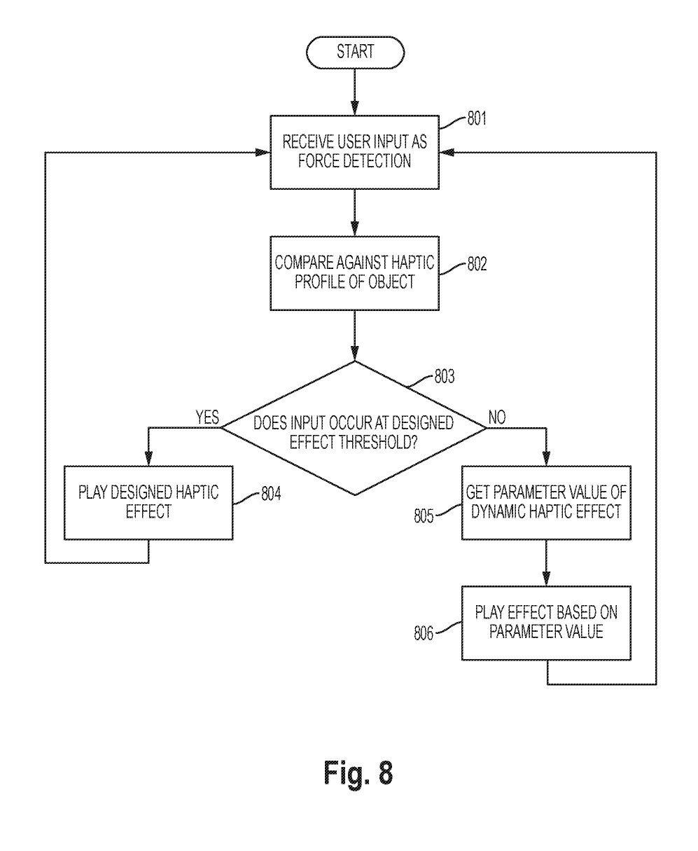

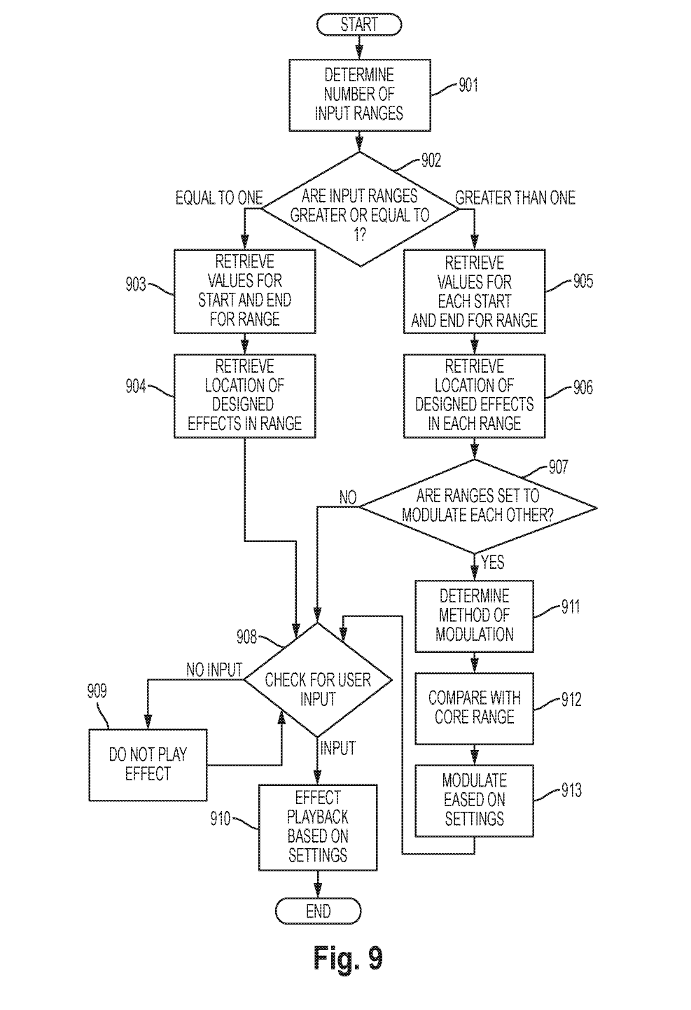

FIG. 8 is a flow diagram of the functionality of system 10 of FIG. 1 when generating a multimodal haptic effect in accordance with an embodiment. In one embodiment, multimodal haptic effect generation module 22, when executed by processor 12, performs the functionality. In one embodiment, the functionality of the flow diagram of FIG. 8 (and FIG. 9 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 801, a user input in the form of a force detection (i.e., pressure based input) is received. In other embodiments, the user input can be in the form of x-y axis positional data instead of pressure based.

At 802, embodiments compare the input against a haptic profile of an object associated with the input. The haptic profile is in the form of a haptic range as shown by haptic range 420 of FIG. 4, or haptic range 503 of FIG. 5, and provides haptic effects that correspond to user input and corresponds to an input range (e.g., input range 410 of FIG. 4 or 502 of FIG. 5). The haptic effects in one embodiment are a combination of at least one dynamic haptic effect (in dynamic portion of the haptic profile) and at least one triggered static haptic effect (at a trigger position of the haptic profile).

At 803, embodiments compare the input with designed effect thresholds or triggers on the haptic profile and determine if the input occurred at a designed effect trigger (e.g., trigger 412 of FIG. 4). For example, an amount of pressure can correspond to the trigger location along the sensor input range.

If yes at 803, at 804 the designed haptic effect is played by the haptic output device. The designed haptic effect in one embodiment is a static haptic effect that can be predefined.

If no at 803, at 805 embodiments retrieve a parameter value of a dynamic haptic effect and at 806 play the haptic effect based on the parameter value. In one embodiment, the dynamic effect is generated using granular synthesis, using the parameter value as an input. In another embodiment, the dynamic effect is generated using interpolation, using the parameter value as an input. The parameter values can be defined in tool 700, in source code, or by other means.

In addition to force/pressure input at 801, input may also be in the form of directionality, velocity, acceleration, lift, roll, yaw, etc., or any type of input that a device may encounter. Devices may include handheld and/or wearable devices. Wearable devices may include, for example, gloves, vests, hats, helmets, boots, pants, shirts, glasses, goggles, watches, jewelry, other accessories, etc. Devices may be physical structures or devices may be generated as part of an augmented or virtual reality. Sensors detecting input may be physical sensors or they may be virtual sensors. Input may cause an effect on the device upon which the input is detected or upon another device linked physically or wirelessly with the effected device.

FIG. 9 is a flow diagram of the functionality of system 10 of FIG. 1 when generating a multimodal haptic effect in accordance with an embodiment. In one embodiment, multimodal haptic effect generation module 22, when executed by processor 12, performs the functionality.

At 901, embodiments determine a number of input ranges. In some embodiments, multiple different haptic ranges correspond to the same user input range. For example, referring to FIG. 4, in addition to haptic range 420 when pressure is increasing (i.e., the user is pushing on the button), there may be a different haptic range when the user is releasing/decreasing pressure on the button so as to create different haptic effects for increasing and decreasing pressure.

Therefore, multiple ranges may be tied to different states, such as one effect range for button pre-activation, one effect range for button post-activation with an increasing force, and one effect range for button post-activation with a decreasing force. Effect range settings may be based on granular, or parameters defined by another means, which may or may not be tied to other elements, such as within a game engine. There may be one or more points (or key frames) containing parametric values, between which parametric values are interpolated.

At 902, embodiments determine whether the number of input ranges are greater or equal to one.

If there is one input range at 902, then at 903, embodiments retrieve values for the start and the end of the input range (e.g., the values of haptic range 420 of FIG. 4). At 904, embodiments retrieve a location of the designed effects in the range. For example, the designed/predefined haptic effects may be stored in memory in the form of a haptic primitive. Memory 20 can be used for storage, or any other available storage location, including remotely using cloud storage.

If there is more than one input range at 902 (e.g., two or more input ranges), then at 905 embodiments retrieve values for the start and the end for each of the input ranges. At 906, embodiments retrieve locations of the designed effects for each of the ranges.

At 907, embodiments determine whether there are multiple concurrent ranges that are set to modulate each other. For example, in some cases there may be multiple sensor inputs that have their own modal profiles, that are affecting the multimodal output at the same time. A multimodal effect is divided into different ranges. Each range can use different modulation methods, which calculate the dynamic haptic effect parameters according to the input value. Those modulation methods of each range are stored in the effect settings. While playing the effect, the application will check the effect setting to see what range the current input value belongs to and calculate correct haptic effect parameters based on the modulation method for this range.

If yes at 907, at 911 the method of modulation is determined. At 912, the method is compared to the core range. At 913, the designed effect is modulated based on the settings. For example, a slide gesture on the screen might have a modal profile that results in a haptic magnitude within a certain range, whereas the haptic signal resulting from same slide gesture when performed while moving the device is modulated by the input of the accelerometer in combination with the slide gesture.

If no at 907, or after 904 or 903, embodiments check for user input (e.g., pressure based or positional input). If the system detects user input, embodiments play the haptic effect as described in FIG. 8. If there is no input, at 909 no haptic effect is played.

In connection with the stored designed effects retrieved at 904 and 905, there may be one or more designed base effects, and they may be in the form of haptic primitives having predefined haptic parameters such as frequency, magnitude and duration. These haptic primitives, or “base effects” may be modified for dynamic effects (e.g., via modulation). The values of a designed effect may be used for parametric values.

Dynamic effects may require modification of the base effects of strength, frequency (i.e., signal width and/or a gap between signal width), and signal shape (e.g., a sine wave, a triangle wave, a square wave, a saw tooth up wave, or a saw tooth down wave). The ranges for haptic settings may be stored as a property of at least an object, a surface, a material, or a physics-based value (e.g., weight, friction, etc.).

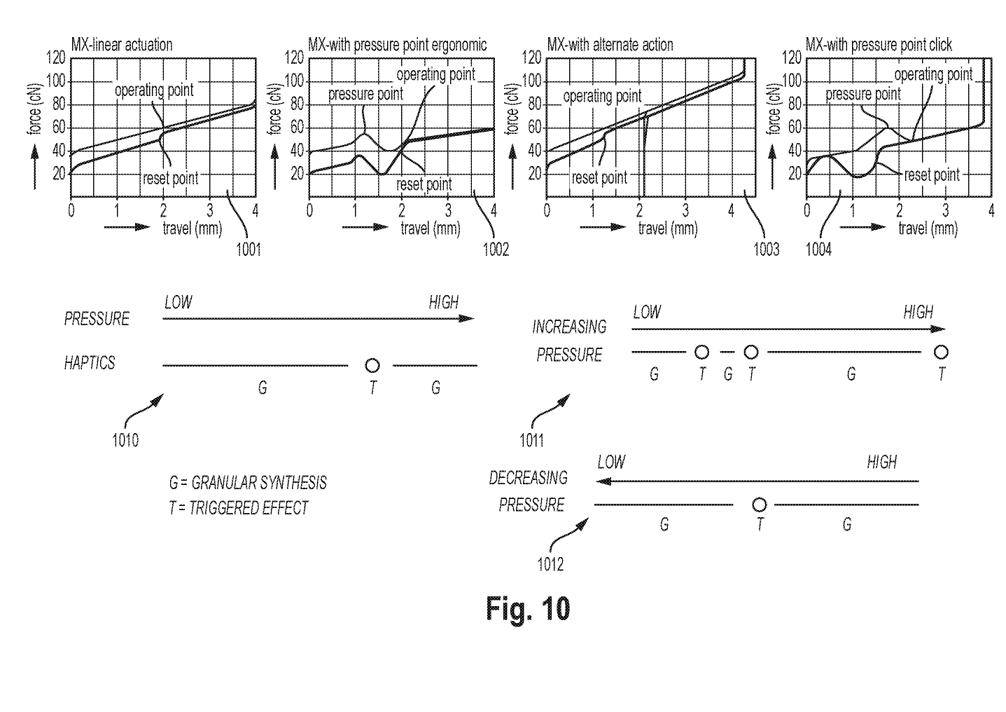

Embodiments can generate physics-based haptic profiles (i.e., haptic ranges corresponding to user input) based on profiles of real world objects. FIG. 10 illustrates profiles of mechanical switches/buttons, and the generation of haptic profiles that allow haptic effects to be generated for simulated buttons in accordance to one embodiment. FIG. 10 illustrates force profiles 1001-1004 of four different mechanical switches and corresponding haptic profiles in accordance with embodiments of the invention.

At 1001, the switch has a linear actuation, with an operating point and a reset point. At 1002, the switch has a pressure point ergonomic with an operating point, a reset point, and a pressure point. At 1003, the switch has an alternative action with an operating point and a pressure point. At 1004, the switch has a pressure point click with an operating point, a reset point, and a pressure point.

Embodiments create a new mapping of haptic design parameters to a model of key travel. Embodiments allow for an arbitrary number of critical points represented by triggered haptic, audio, and visual effects, and model hysteresis with a separate haptic mapping for decreasing pressure from the one for increasing pressure. In this way, embodiments allow for force profiles and audio profiles from mechanical keys to be modeled with digital haptic and audio feedback in a way that an equivalent experience is generated. Example mappings 1010-1012 are shown in FIG. 10.

As another example, physics-based haptic profiles can be used for simulations of real world objects that have a combination of fine tactile features and gross tactile features and are based on the physical properties of the objects. For example, a thin wooden beam such as the type in a wood floor can be simulated. The simulation of the wooden beam includes fine tactile features, so when the beam is bent through a compliance interaction, fibers internal to the wood may strain or break, giving rise to a tactile sensation. However, it may be difficult to model each straining or breaking fiber and outputting a haptic effect for each fiber-strain event. It would not only be onerous to design this interaction, it would be computationally intensive. Instead, embodiments can use a higher level mapping from pressure gesture to dynamic effect parameters to render the fine tactile features.

The simulation of the wooden beam also includes gross tactile features so when the beam bends a certain amount, larger fibers are going to crack. The tactile sensation of these cracks is that of high magnitude, short duration events with some envelope qualities (e.g., attack, decay, etc.). There may be some textural elements to these events but they take place in very short timeframes. These can be well simulated with triggered haptic, audio, and visual events. Using the dynamic effect mapping used for the fine tactile features is less practical because there is a need to define key frames in very short time durations. Therefore, combining dynamic effects with static triggered effects can be used to simulate compliance properties of materials and other audio, visual, and haptic properties of the materials.

As disclosed, embodiments simulate and mimic real-world elements or component by generating and input range and a corresponding haptic profile that includes both dynamic haptic effects (e.g., using granular synthesis) and a triggered static haptic effect. The multimodal combination of haptic effects provides an enhanced feeling to simulate, for example, material compliance in response to a pressure based input. Further, audio and/or visual feedback may be generated in conjunction with the dynamic haptic effect or the static haptic effect

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of generating haptic effects in response to a user input, the method comprising:
receiving a first input range corresponding to user input;
receiving a haptic profile corresponding to the first input range;
during a first dynamic portion of the haptic profile, generating a dynamic haptic effect that varies based on values of the first input range during the first dynamic portion; and
at a first trigger position of the haptic profile, generating a triggered haptic effect.

2. The method of claim 1, further comprising:
during a second dynamic portion of the haptic profile, generating a dynamic haptic effect that varies based on values of the first input range during the second dynamic portion.

3. The method of claim 1, wherein at least a portion of the dynamic haptic effect is generated using granular synthesis.

4. The method of claim 1, wherein at least a portion of the dynamic haptic effect is generated using interpolation.

5. The method of claim 1, wherein the user input is applied to a touchscreen, and the first input range corresponds to a range of pressure applied to the touchscreen by the user input.

6. The method of claim 1, wherein the user input is applied to a touchscreen, and the first input range corresponds to touch positions on the touchscreen.

7. The method of claim 1, wherein the haptic profile is based on physical properties of an element to be simulated.

8. The method of claim 7, wherein the element is one of a button or a material.

9. The method of claim 1, further comprising receiving a second input range, wherein generating the dynamic haptic effect comprises the first input range modulating the second input range.

10. The method of claim 1, further comprising audio and/or visual feedback in conjunction with the dynamic haptic effect or the triggered haptic effect.

11. The method of claim 1, wherein the user input is pressure based and the dynamic haptic effect further varies based on whether the user input corresponds to increasing pressure or decreasing pressure.

12. The method of claim 1, wherein the user input is a slide gesture and the dynamic haptic effect further varies based on a direction and a velocity of the slide gesture.

13. The method of claim 1, wherein the user input comprises both pressure based input and a slide gesture.

14. A non-transitory computer readable medium having instructions stored thereon that, when executed by a processor, cause the processor to generate haptic effects in response to a user input, the generating haptic effects comprising:
receiving a first input range corresponding to user input;
receiving a haptic profile corresponding to the first input range;
during a first dynamic portion of the haptic profile, generating a dynamic haptic effect that varies based on values of the first input range during the first dynamic portion; and
at a first trigger position of the haptic profile, generating a triggered haptic effect.

15. The non-transitory computer readable medium of claim 14, further comprising:
during a second dynamic portion of the haptic profile, generating a dynamic haptic effect that varies based on values of the first input range during the second dynamic portion.

16. The non-transitory computer readable medium of claim 14, wherein at least a portion of the dynamic haptic effect is generated using granular synthesis.

17. The non-transitory computer readable medium of claim 14, wherein at least a portion of the dynamic haptic effect is generated using interpolation.

18. The non-transitory computer readable medium of claim 14, wherein the user input is applied to a touchscreen, and the first input range corresponds to a range of pressure applied to the touchscreen by the user input.

19. The non-transitory computer readable medium of claim 14, wherein the user input is applied to a touchscreen, and the first input range corresponds to touch positions on the touchscreen.

20. A haptically-enabled system comprising;
a processor;
a haptic output device coupled to the processor;
a user interface coupled to the processor;
wherein the processor, when executing instructions:
receives a first input range corresponding to user input on the user interface, and receives a haptic profile corresponding to the first input range;
during a first dynamic portion of the haptic profile, generates a dynamic haptic effect using the haptic output device that varies based on values of the first input range during the first dynamic portion; and
at a first trigger position of the haptic profile, generates a triggered haptic effect using the haptic output device.
